(19) United States
(12) Patent Application Publication
(10) Pub. No.: US 2014/0032374 A1
(43) Pub. Date: Jan. 30, 2014

(54) EBOOK MANAGEMENT AND FULFILLMENT SYSTEM

(71) Applicant: Anthony R. Pfister, Castleton, NY (US)

(72) Inventor: Anthony R. Pfister, Castleton, NY (US)

(21) Appl. No.: 14/014,595

(22) Filed: Aug. 30, 2013

Related U.S. Application Data
(63) Continuation-in-part of application No. 13/556,536, filed on Jul. 24, 2012.

(51) Int. Cl. G06Q 30/06; G06Q 50/20

(52) U.S. Cl. CPC G06Q 30/0635; G06Q 50/20
USPC 705/26.81

(57) ABSTRACT

Embodiments of the present invention provide an approach for indexing and providing electronic publications in a networked computing environment. Specifically, embodiments of the present invention provide an ebook distribution engine that has a database for storing and managing data, including: ebook data from a plurality of ebook vendors; curriculum data for a plurality of schools; and fulfillment data including ebook purchase information for individual students at each of the plurality schools; a back office manager having an interface into the database for managing the curriculum data; a publication manager for importing ebook data from the plurality of ebook vendors into the database; and a fulfillment system that effectuates purchase and delivery of ebooks from the ebook vendors to the students.

This application is a continuation-in-part of copending application Ser. No. 13/556,536 filed on Jul. 24, 2012, entitled INDEXING AND PROVIDING ELECTRONIC PUBLICATIONS IN A NETWORKED COMPUTING ENVIRONMENT, the contents of which is hereby incorporated by reference.

### TECHNICAL FIELD

In general, embodiments of the present invention relate to electronic publications. Specifically, embodiments of the present invention relate to the indexing and provision of electronic publications (e.g., education books) in a networked computing environment (e.g., a cloud computing environment).

### BACKGROUND OF THE INVENTION

As the use of electronic reading devices continues to grow, an increasing number of people are relying less on printed publications and instead utilizing electronic reading devices such as the Nook® and/or Kindle®. In addition, many other types of devices such as tablets, smart phones, etc., have the capability to download proprietary applications in which electronic books can be launched.

Unfortunately, no existing approach allows such technology to be fully leveraged in an educational and/or similar environment. Rather, existing approaches typically involve a user selecting a specific book from an on-line bookstore or the like, and then launching the same using an electronic reading device and/or application. Such a targeted approach fails to address specific idiosyncrasies of an educational environment such as course-specific materials and overall access control.

### SUMMARY

In general, embodiments of the present invention provide an approach for indexing and providing electronic publications (e.g., books) in a networked computing environment. Specifically, embodiments of the present invention provide a publication application in which course instructors (e.g., in an educational embodiment) may designate books available for their students, and students may view and obtain such available publications. The embodiments of present invention allows for management of curriculums in electronic formats over multiple readers, tablets and applications by providing a central location for students' electronic purchases, directing a student/user to a correct reader to launch corresponding content when needed.

In a typical embodiment, a student/user will log into an application (e.g., from an electronic device such as a computer, a tablet, a smart phone, etc.) and view a list of courses in which the student is enrolled and/or publications available thereto. A student may select a publication from the list upon which the publication application may: obtain the selected publication, detect a format thereof, launch an appropriate electronic reading application (e.g., based on the detected format of the electronic publication), and display the electronic publication using the electronic reading application. If the electronic reading application is not already installed on the user's electronic device, the publication application may download the needed reading application.

A first aspect of the present invention provides a computer-implemented method for providing electronic publications in a networked computing environment, comprising: providing a list of electronic publications available to a user via a publication application on an electronic device; receiving a selection of an electronic publication from the list of electronic publications; determining a format of the electronic publication for display on the electronic device; launching an electronic reader application on the electronic device based on the format; and displaying the electronic publication on the electronic device with the electronic reader application.

A second aspect of the present invention provides a system for providing electronic publications in a networked computing environment, comprising: a memory medium comprising instructions; a bus coupled to the memory medium; and a processor coupled to the bus that when executing the instructions causes the system to: pile a list of electronic publications available to a user via a publication application on an electronic device; receive a selection of an electronic publication from the list of electronic publications; determine a format of the electronic publication for display on the electronic device; launch an electronic reader application on the electronic device based on the format; and display the electronic publication on the electronic device with the electronic reader application.

A third aspect of the present invention provides a computer program product for providing electronic publications in a networked computing environment, the computer program product comprising a computer readable storage media, and program instructions stored on the computer readable storage media, to: provide a list of electronic publications available to a user via a publication application on an electronic device; receive a selection of an electronic publication from the list of electronic publications; determine a format of the electronic publication for display on the electronic device; launch an electronic reader application on the electronic device based on the format; and display the electronic publication on the electronic device with the electronic reader application.

A fourth aspect of the present invention provides a method for deploying a system for providing electronic publications in a networked computing environment, comprising: providing a computer infrastructure being operable to: provide a list of electronic publications available to a user via a publication application on an electronic device; receive a selection of an electronic publication from the list of electronic publications; determine a format of the electronic publication for display on the electronic device; launch an electronic reader application on the electronic device based on the format; and display the electronic publication on the electronic device with the electronic reader application.

A fifth aspect of the invention provides an ebook distribution engine, comprising: a database for storing and managing data, including: ebook data from a plurality of ebook vendors; curriculum data for a plurality of schools; and fulfillment data including ebook purchase information for individual students at each of the plurality schools; a back office manager having an interface into the database for managing the curriculum data; a publication manager for importing ebook data from the plurality of ebook vendors into the database; and a fulfillment system that effectuates purchase and delivery of ebooks from the ebook vendors to the students.

A sixth aspect of the invention provides a computer program product stored on a computer readable medium, which when executed by a computer system having a processor and memory, provides an ebook distribution engine, the computer program product comprising: a database for storing and managing data, including: ebook data from a plurality of ebook vendors; curriculum data for a plurality of schools; and fulfillment data including ebook purchase information for individual students at each of the plurality schools; program code that provides an interface into the database for managing the curriculum data; program code for importing ebook data from the plurality of ebook vendors into the database; and program code that effectuates purchase and delivery of ebooks from the ebook vendors to the students.

A seventh aspect of the invention provides a fulfillment system for distributing ebooks, comprising: a computing system having a memory and processor; a database for storing and managing ebook data from a plurality of ebook vendors; an on-line store that outputs a list of selected ebooks available from the plurality of ebook vendors and that collects payment data to initiate ebook purchases from the plurality of ebook vendors; a code retrieval system that obtains purchase codes from the plurality of ebook vendors in response to collected payment data and that stores the purchase codes along with a user id in the database; and an auto-fulfill system that automatically submits purchase codes to the set of ebook vendors to obtain access to purchased ebooks for an associated user id.

An eight aspect of the invention provides a computerized method for distributing ebooks, comprising: providing a computer database for storing and managing ebook data from a plurality of ebook vendors; outputting a list of selected ebooks available from the plurality of ebook vendors to a user interface on a remote computing device; collecting payment data from the user interface to initiate ebook purchases from the plurality of ebook vendors; obtaining purchase codes from the plurality of ebook vendors in response to collected payment data and storing the purchase codes along with a user id in the database; and automatically submitting purchase codes to the plurality of ebook vendors to obtain electronic access to purchased ebooks for an associated user id.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computing node according to an embodiment of the present invention.

FIG. 2 depicts a system diagram according to an embodiment of the present invention.

FIG. 3 depicts a method flow diagram according to an embodiment of the present invention.

FIG. 4 depicts an exemplary screenshot of a system login page.

FIG. 5 depicts an exemplary screenshot of a interface page showing course subjects.

FIG. 6 shows an exemplary screenshot of a interface page displaying the publications available to a user for a particular course subject.

FIG. 7 shows an exemplary screenshot 700 of another interface page displaying the publications available to a user for a difference course subject (from that shown in FIG. 6).

FIG. 8 depicts an illustrative electronic publication engine according to an embodiment of the present invention.

FIG. 9 depicts a first illustrative view of data from the master database according to an embodiment of the present invention.

FIG. 10 depicts a second illustrative view of data from the master database according to an embodiment of the present invention.

FIG. 11 depicts a third illustrative view of data from the master database according to an embodiment of the present invention.

FIG. 12 depicts an illustrative publication manager according to an embodiment of the present invention.

FIG. 13 depicts an illustrative back office manager according to an embodiment of the present invention.

FIG. 14 depicts an online store according to an embodiment of the present invention.

FIG. 15 depicts a flow diagram showing an illustrative fulfillment process according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The word “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As indicated above, embodiments of the present invention provide an approach for indexing and providing electronic publications (e.g., books) in a networked computing environment. Specifically, embodiments of the present invention provide a publication application in which course instructors (e.g., in an educational embodiment) may designate books available for their students, and students may view and obtain such available publications. In a typical embodiment, a student/user will log into the application (e.g., from an electronic device such as a computer, a tablet, a smart phone, etc.) and view a list of courses in which the student is enrolled and/or publications available thereto. A student may select a publication from the list upon which the publication application may: obtain the selected publication, detect a format of the publication, launch an appropriate electronic reading application (e.g., based on the detected format of the electronic publication), and display the publication using the electronic reading application. If the electronic reading application is not already installed on the user's electronic device, the publication application may download the same.

It should be understood that although in a typical embodiment the teachings recited herein may be applied to an educational environment, this need not be the case. Rather, these teachings could be applied to any to any type environment for which information exchange is desired.

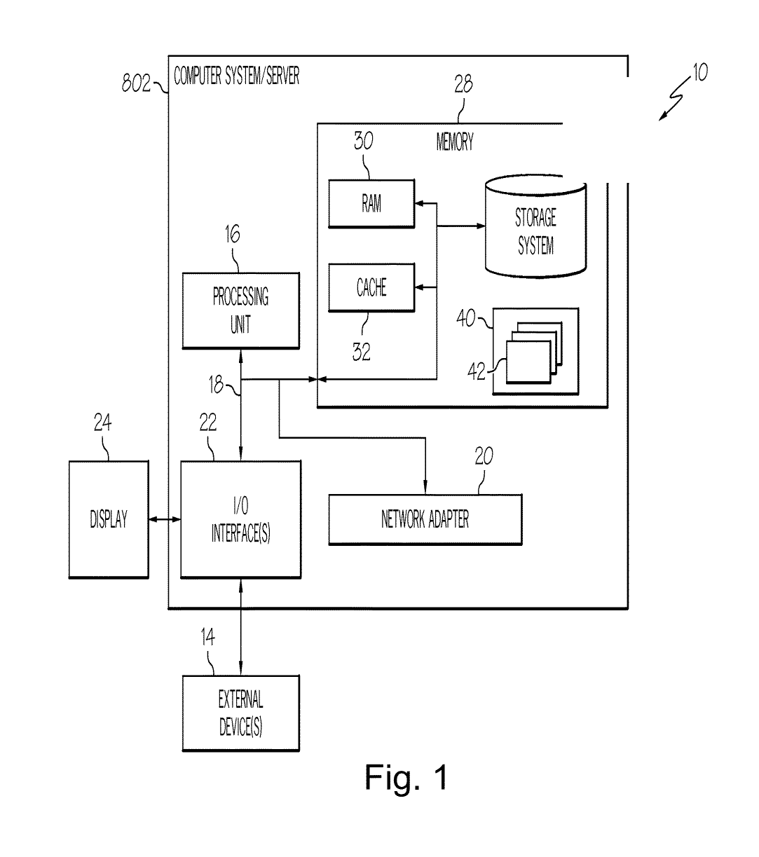

Referring now to FIG. 1, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, mobile devices, global positioning systems (GPS), GPS-enable devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on, which perform particular tasks or implement particular abstract data types. Computer system/server 12 may be practiced in distributed/networked computing environments (e.g., cloud computing environments) where tasks are performed by remote processing devices that are linked through a communications network. In a distributed computing environment, program modules may be located in both local and remote computer system storage media including memory storage devices.

As shown in FIG. 1, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVDROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Electronic publication program/utility 40, having a set (at least one) of program modules 42, may be stored in memory 28 by way of example, and not limitation, as well as an operating system, one or more application programs, other program modules, and program data. In general, Electronic publication 40 performs the function of the present invention as described herein. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

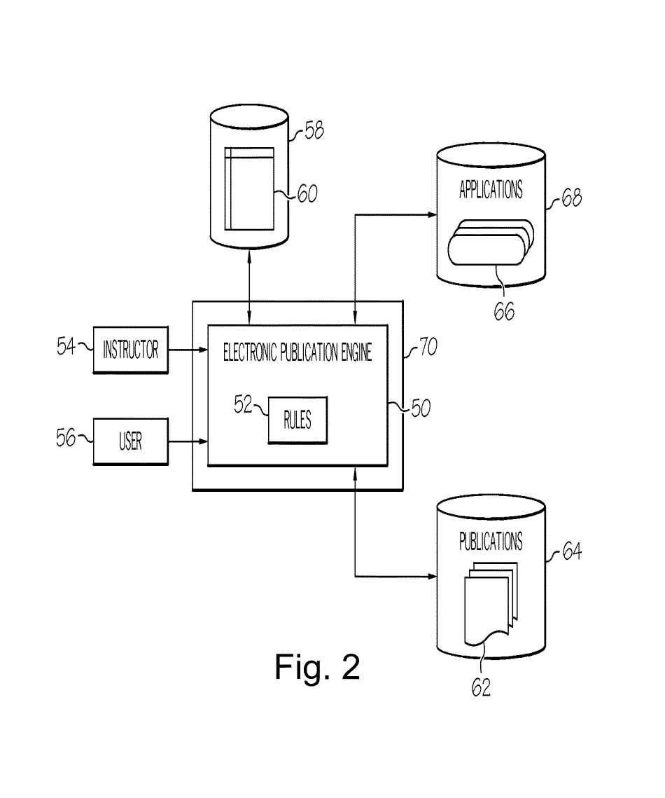

Referring now to FIG. 2, a system diagram describing the functionality discussed herein according to an embodiment of the present invention is shown. It is understood that the teachings recited herein may be practiced within any type of networked computing environment (e.g., a cloud computing environment). A computer system/server 12, which can be implemented as either a stand-alone computer system, or as a networked computer system is shown in FIG. 2. In the event the teachings recited herein are practiced in a networked computing environment, each client need not have an electronic publication engine (engine 50). Rather, engine 50 could be loaded on a server or server-capable device that communicates (e.g., wirelessly) with the clients to provide electronic publication functionality hereunder. Regardless, as depicted, engine 50 is shown within electronic device 70 (e.g., computer system 12 of FIG. 1). In general, engine 50 can be implemented as program/utility 40 on computer system 12 of FIG. 1 and can enable the functions recited herein. As further shown, engine 50 (in one embodiment) comprises a rules and/or computational engine that processes a set (at least one) of rules/logic 52 and/or provides electronic publication indexing and provision functionality hereunder.

Along these lines, engine 50 may perform multiple functions similar to a general-purpose computer. Specifically, among other functions, engine 50 may (among other things): provide a list/index 60 (e.g., stored in a computer storage device/database 58) of electronic publications (electronic books offered for educational courses as designated by instructor 54) available to a user 56 (e.g., a student) of an electronic device 70; receive a selection of an electronic publication 62 from the list 60 of electronic publications; determine a format of the electronic publication 62 for display on the electronic device 70; download/obtain the electronic publication 62 (e.g., from a database 64); obtain/install an electronic reader application 66 (e.g., from database 68) on the electronic device 70 based on the format; launch the electronic reader application 66 on the electronic device 70; display the electronic publication 62 on the electronic device 70 with the electronic reader application 66.

### Illustrative Example

This flow will be further described in conjunction with an illustrative example. This example, an educational setting is defined with the roles of teacher and student whereby a student is obtaining an electronic book for a course he/she is taking. Moreover, in this example, all functions should be understood to be implemented and/or enabled via engine 50 (e.g., program 40 of FIG. 1). Regardless, in this example, the following actions may be performed:
Teacher/Administrator: Logs in to school-specific “Back Office Manager” or similar component of engine 50; Enters course information; Selects books to use for course; Engine 50 shows electronic books available from multiple vendors for each book selected; and Teacher/admin selects which electronic books to offer to students.

Student: Logs in to a school specific site;
Purchases books by going to each of their courses (or alternatively via purchase code from a bookstore that may have a specific format); Selects from available print and/or electronic book versions authorized by teacher; Purchases books; Downloads application to desktop or portable device; Logs in to application; Sees a list of courses for their school; and Sees a list of available books, books purchased, (print and/or electronic book) for each course. The list may have associated therewith an information display showing one or more of purchase status, links to purchase, and links to launch electronic book regardless of supplier. Along these lines, the list may display a title to launch (e.g., via a link) in an object-oriented approach.
System: Maintains a list of available print titles; Maintains a list of available electronic book titles from multiple vendors; and cross references from electronic books to print; Displays this list to teachers and allows them to approve books for use; Displays approved list to students and allows them to purchase; and Maintains knowledge of how to access each type of electronic book.

In general, application/engine 50 may be configured to determine what is possible regarding each vendor. In some cases, this may comprise informing the student that they have purchased the book and providing a link to access it via the web. In other cases, engine 50 may give students a link to launch an appropriate electronic reading application (e.g., based on the format of the electronic book. This may be done by accessing a URL from the web page of the format (e.g., kindle://). On iOS devices, this may include searching for any application that is responding to that URL. If so, engine 50 may launch such application. So, for example, Amazon's Kindle® application currently responds to such a command/URL and launches when it is accessed (i.e., even if the user were to enter the URL in a web browser). Still yet, engine 50 may be configured to scan electronic device 70 and detect an electronic reading application already loaded thereon. In such an embodiment, engine 50 may obtain the selected electronic book in a format suitable to the electronic reading application. If the electronic book is unavailable in such a format, engine 50 may obtain the necessary electronic reading application for the device.

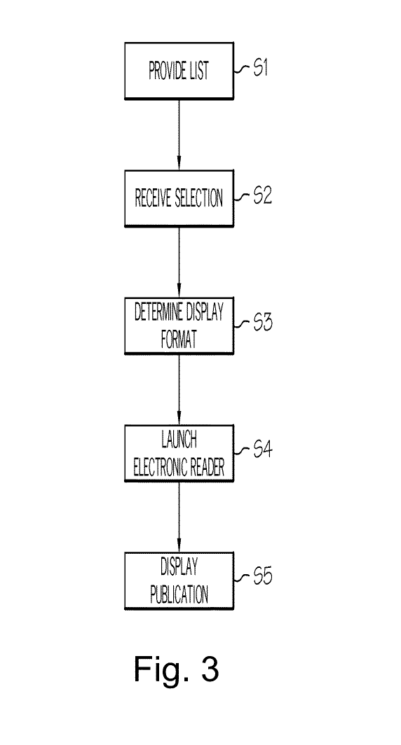

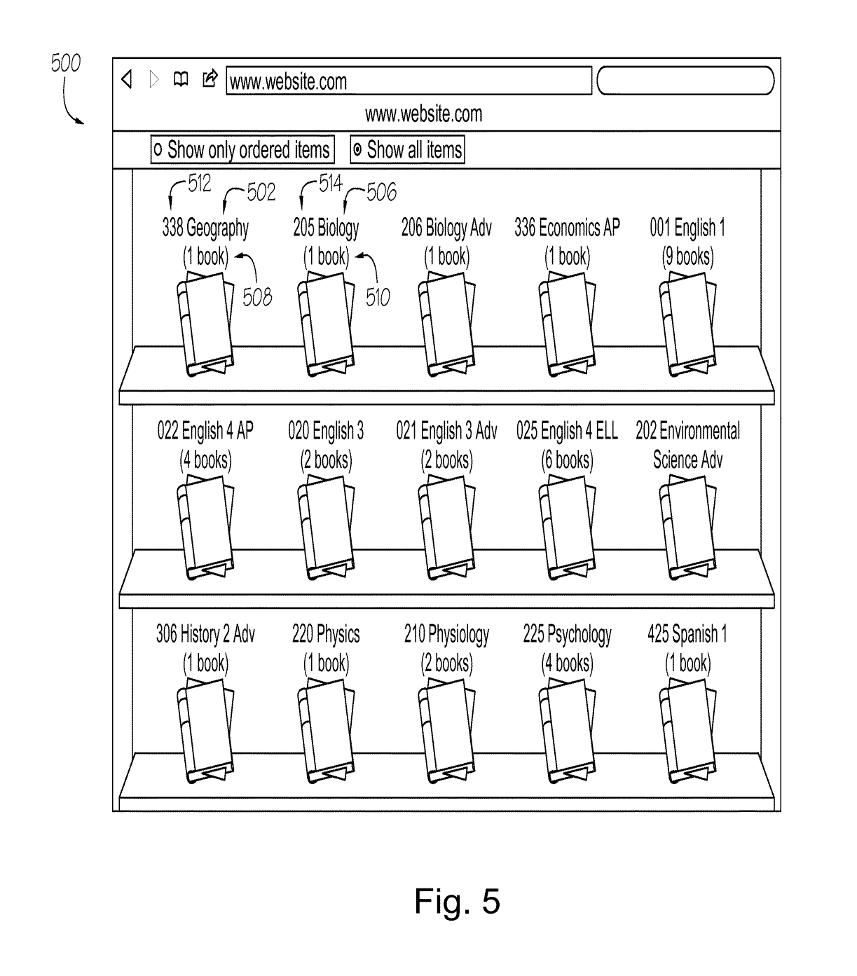

Referring now to FIG. 3, a method flow diagram according to an embodiment of the present invention is shown (e.g., as enabled by engine 50 of FIG. 2). As depicted, in step S1, a list of electronic publications available to a user via a publication application on an electronic device is provided. The list may comprise a “single-layer” list, for example, the publications may simply be displayed based in a logical order such as (without limitation) alphabetical order of the publication name or author, or comprise a “multilayer” list, for example, in which the publications are organized into folders corresponding to course subjects to which each publication is associated (e.g., FIG. 5). Additionally, for each publication, the following may be shown:

purchase status, links to purchase, and links to launch electronic book regardless of supplier, etc. In step S2, a selection of an electronic publication from the list of electronic publications is received, for example, by a user clicking a mouse or touching a touch screen. In step S3, a format of the electronic publication for display on the electronic device is determined. In step S4, an electronic reader application on the electronic device based on the format is launched. In step S5, the electronic publication on the electronic device with the electronic reader application is displayed. It will be recognized that the order of the steps is not limited to that disclosed herein. Any feasible order is considered within the scope of the invention.

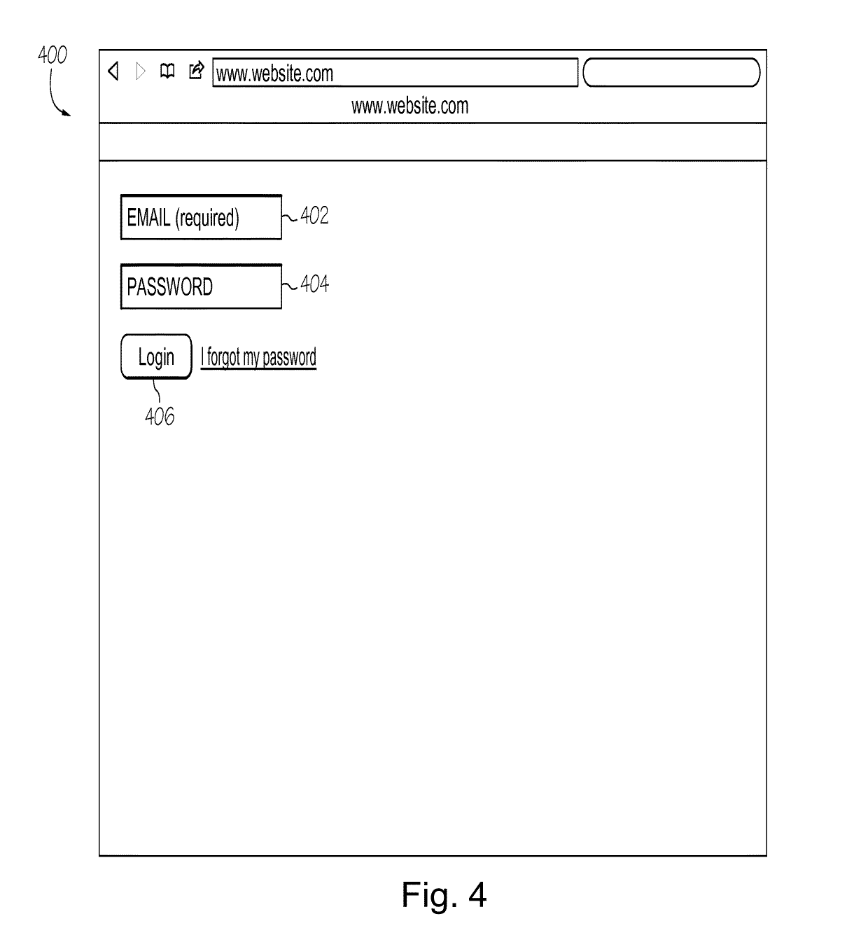

FIGS. 4-7 depict various exemplary interface pages describing some of functionality discussed herein. It is understood that such pages may be web pages, application pages, or any other type of interface page. Referring now to FIG. 4, an exemplary screenshot 400 of a login page is shown. Fields 402 and 404 are available for entry of a username and password, respectively. Also, a login button 306 may be provided. It will be recognized that in practice more or fewer features may be included on a login page of the inventive system.

Referring now to FIG. 5, an exemplary screenshot 500 of an interface page showing course subjects, for example at reference numbers 502 and 506. In some embodiments, a course number may also be displayed, for example at reference number 512 and 514. The number of publications available to the user for each subject is shown relative to each course subject, for example, at reference numbers 508 and 510. In practice, a user can select (by clicking on a mouse or tapping a touch screen, etc.) a course subject for which he wishes to access the associated publications. It will be recognized that in practice more or fewer features may be included on this interface page of the inventive system.

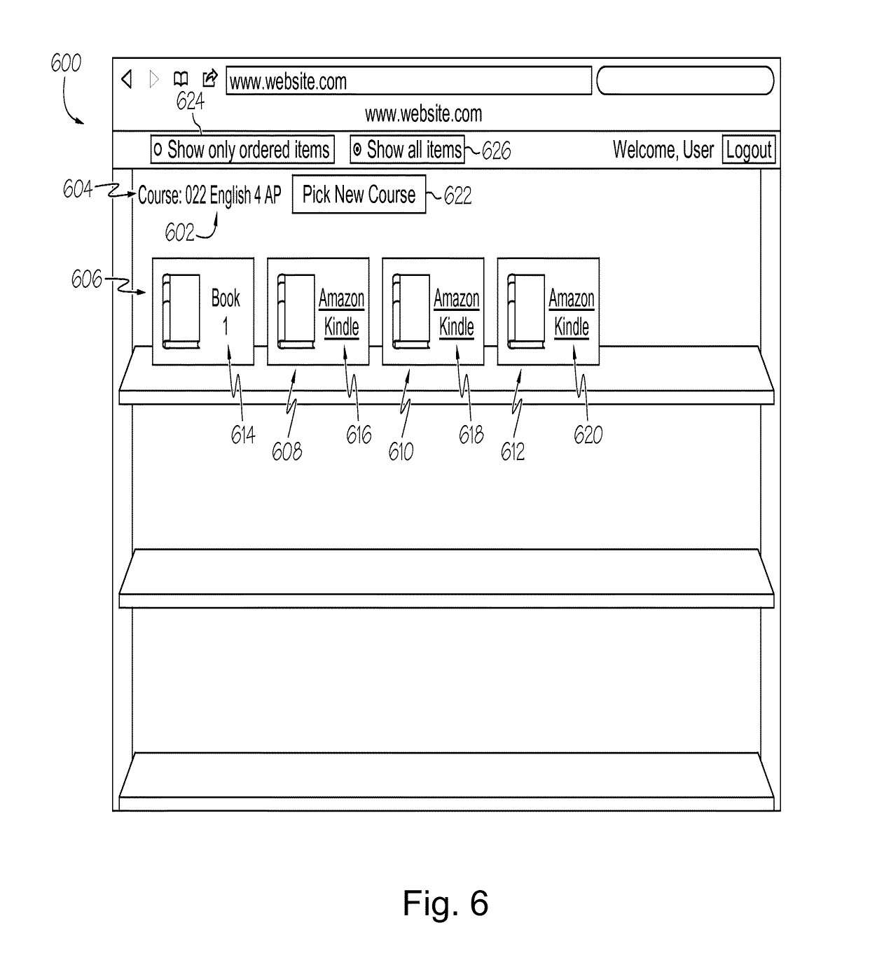

Referring now to FIG. 6, an exemplary screenshot 600 of a interface page displaying the publications available to a user for a particular course subject. The course subject and number may be shown, for example, at reference numbers 602 and 604, respectively. In the exemplary page shown, there are four publications available, shown at reference numbers 606, 608, 610, and 612. The icons may be clickable or tappable to download the publication. It will be recognized that the number of publications is used herein only for the purposes of disclosure, and more or fewer may be shown in implementations of the invention. Also shown associated with each publication is the publication format, for example, at reference numbers 614, 616, 618 and 620. Buttons 624 and 626 are shown allowing a user to switch between viewing all publications available and only those which he ordered. A button 622 may be included for a user to easily select another course subject. It will be recognized that in practice more or fewer features may be included on this interface page of the inventive system.

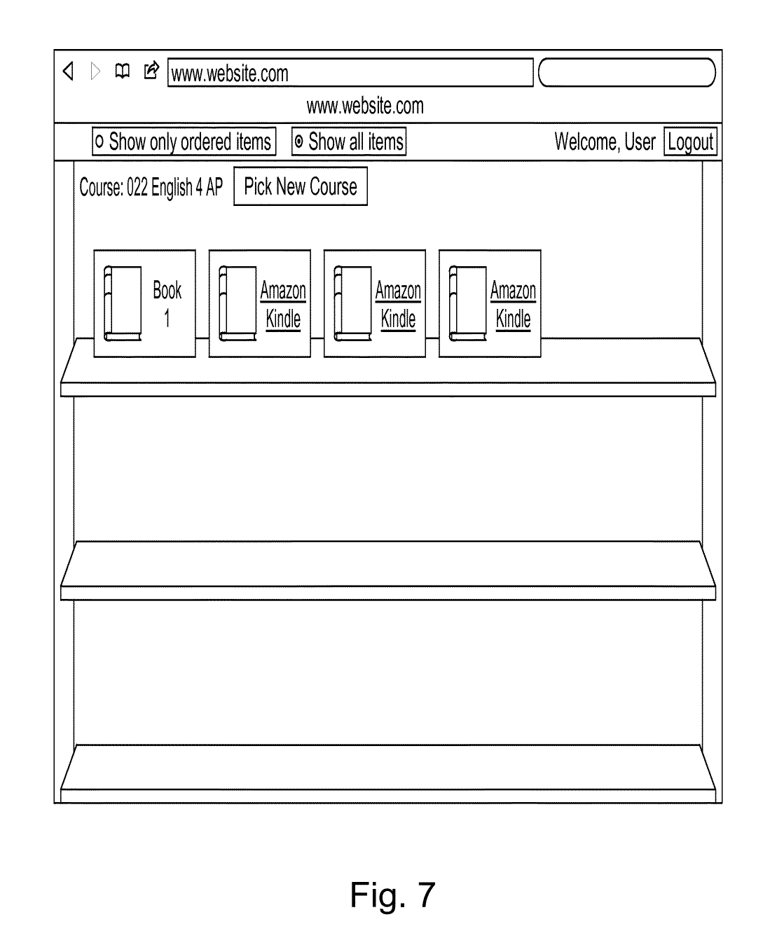

FIG. 7 shows an exemplary screenshot 700 of another interface page displaying the publications available to a user for a difference course subject (from that shown in FIG. 6).

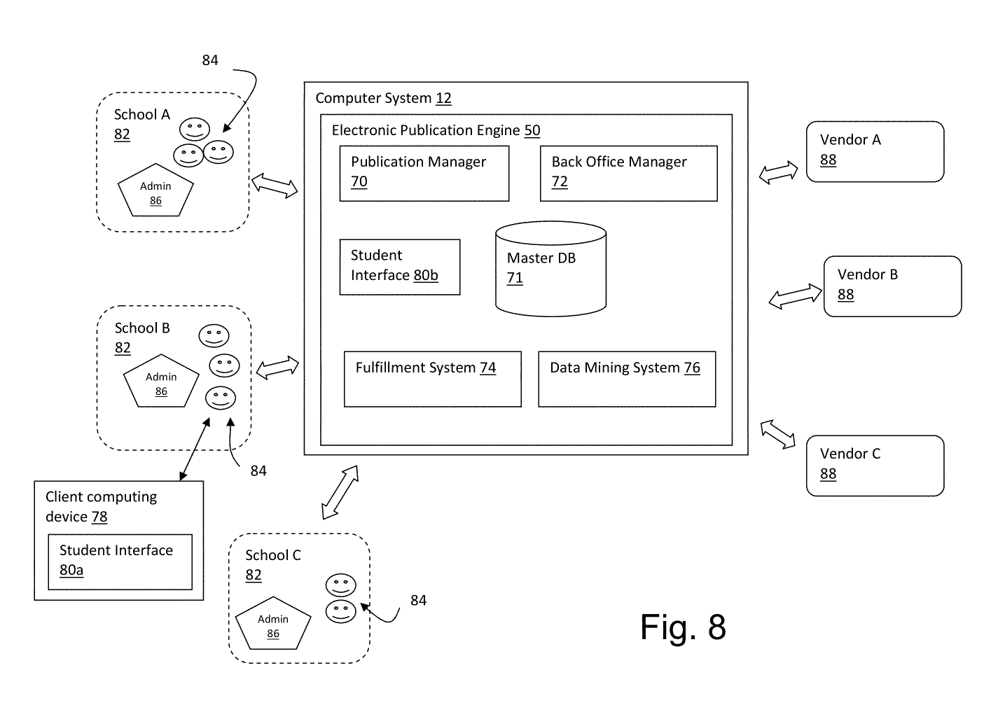

Referring now to FIG. 8, computer system 12 is shown again with electronic publication engine 50. Electronic publication engine 50 provides a comprehensive architecture that allows students 84 associated with different schools 84 to seamlessly obtain electronic publications (i.e., ebooks) for a school curriculum from a plurality of different vendors 88 having disparate ebook formats. Note that for the purposes of this invention (including the claims), the term student should be interpreted to broadly include any type of user; the term school should be interpreted to broadly include any type of institution; the term curriculum should be broadly interpreted to include any selected list of titles or publications and the term ebook should be broadly interpreted to include any type of electronic or digital media.

A central feature to the engine 50 is a master database 71 that maintains: (1) publication data from a plurality of vendors 88; (2) school 82 specific curriculum data information such as course offerings and required reading material; and (3) fulfillment data including student 84 order data. In addition to master database 71, engine 50 includes a publication manager 70 for importing and managing publication data in database 71 from vendors 88; a back office manager 72 for allowing an administrator 86 (e.g., teachers) from a school 82 to manage curriculums used by the school 82; a fulfillment system 76 that interfaces with students and different vendors 88 to effectuate purchase and delivery of publications to the students; and a data mining system 76 that analyzes curriculum and purchase data across participating schools 82 to for example make recommendations. Accordingly, a comprehensive system is provided to effectively manage the distribution of disparate electronic publication formats to students at a plurality of different schools.

In addition, a student interface 80a,b is provided that allows students with a client computing device 78 (e.g., e-reader, tablet, computer, smartphone, etc.) to obtain and view ebooks for an associated curriculum. Depending on the implementation, the student interface 80a,b may be implemented on either/both the client computing device and engine 50. For instance, the student interface 80a,b may comprise a web page served to and viewed in a browser on the client computing device 78, a custom App that resides on the client computing device, or any other arrangement.

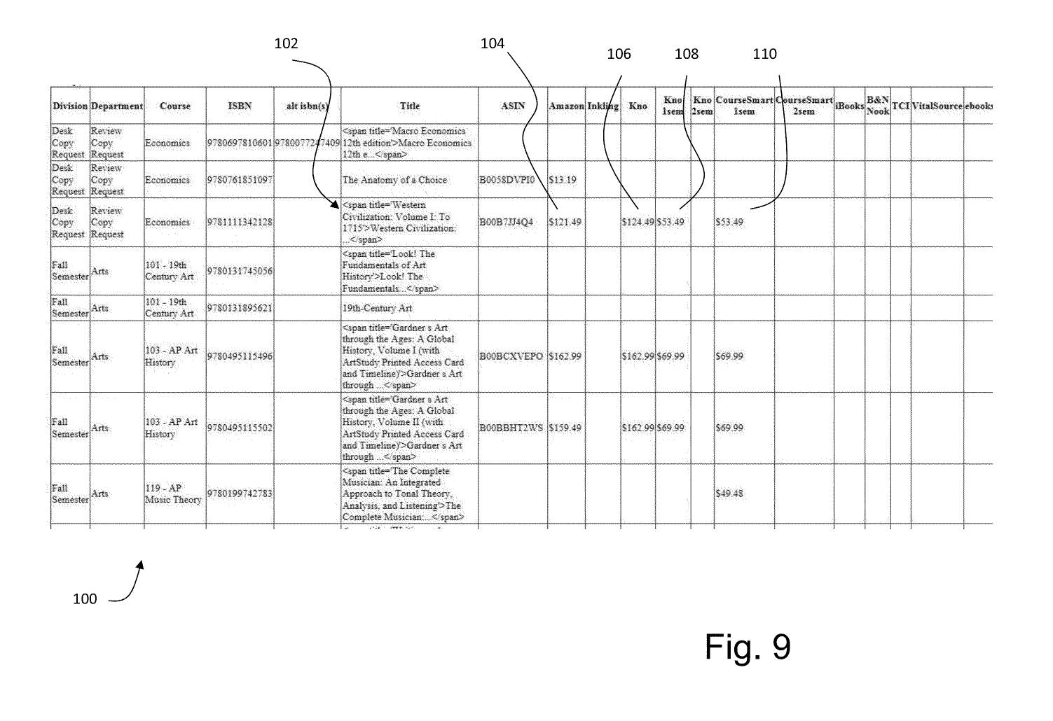

FIGS. 9-11 depict three illustrative views or dimensions of data contained in the master database 71. One of the challenges with providing a multi-vendor ebook solution is that only print editions of books have a universally recognized identifier, e.g., the ISBN number. Thus, there exists no uniform identification scheme for distinguishing a given book among different ebook platforms. For example, a given title (e.g., “Of Mice and Men”) has a universally recognized ISBN identifier, but may be offered in different incompatible ebook formats. The present system provides a mapping system that serves to uniquely identify and distinguish ebooks by vendor platform.

FIG. 9 depicts a first database dimension 100 that provides curriculum information showing data associated with a particular school's book adoption plan. In this example, FIG. 9 shows data for the school's Economics, 19^{th} Century Art and AP Art History classes. Relevant data includes the ISBNs, alternative ISBNs, titles, ASINs, alternative ASINs, and the price/availability from different vendors. As such, this dimension maps ISBN data for a school's curriculum to availability at different ebook vendors. For example, it can be seen that the book “Western Civilization: Volume I To 1715” (102) is available at Amazon 104 for $121.49, Kuo 106 for $124.49, Kuo 1 Semester 108 for $53.49 and CourseSmart 1 Semester (110) for $53.49. Alternative ISBNs indicate a different version of the ebook is available (e.g., hard cover versus paperback).

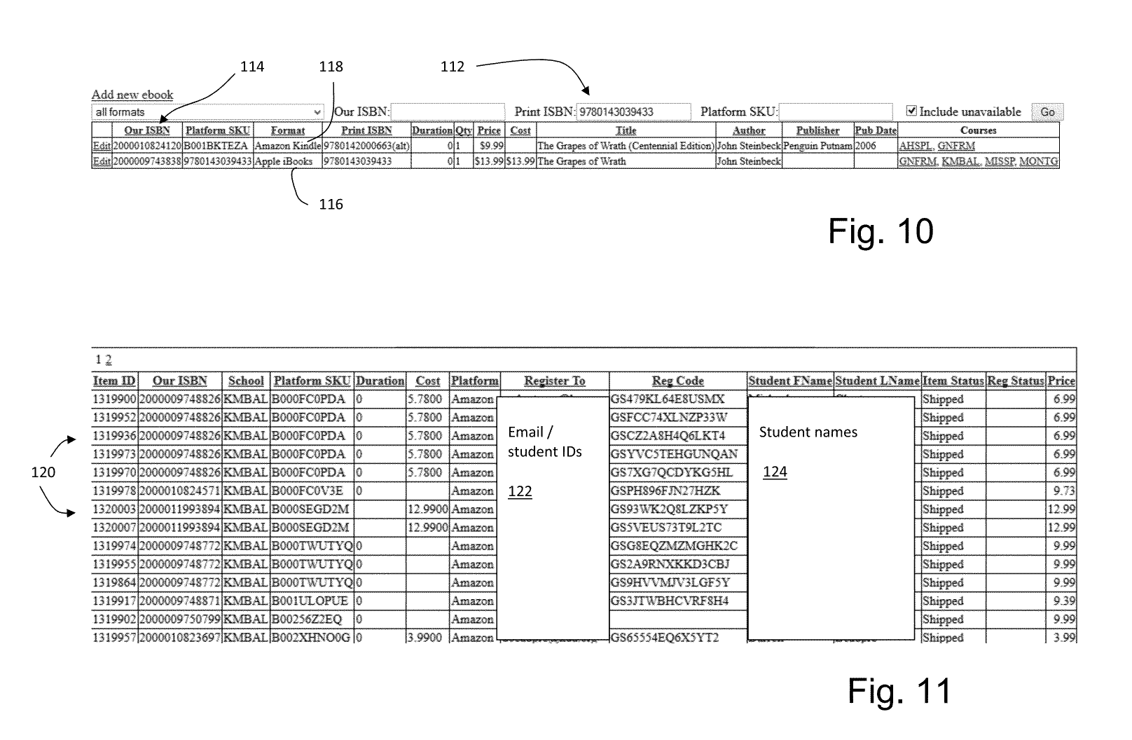

FIG. 10 depicts a second dimension showing availability options for a selected ISBN 112. As noted, the ISBN provides an identifier for a unique title. However, a given ISBN may be available on many different ebook formats. For instance a single ISBN may be available on Kindle, Nook, Kuo. In addition, a given ISBN may have alternative versions, e.g., paperback, annotated versions etc. The publication manager 70 (FIG. 8) assigns each such version a platform specific identifier (shown as “Our ISBN”) 114, thus allowing each instance of an ebook to be uniquely identified and mapped across platforms. In the example of FIG. 10, for the entered ISBN 112, a version of the Grapes of Wrath for the Apple Ibook is shown 116, as well as an alternative version 118 for the Amazon Kindle. Included in each record of this view is the SKU, the vendor/format on which the ebook is available, price and cost information, title/author/publisher information, and courses in which this book has been used. The cross-mapping feature of the electronic publication engine 50 thus allows ebook titles to be linked, searched and uniquely identified across platforms.

FIG. 11 depicts a third database dimension showing fulfillment data for a set of students at a given school. As shown, this view includes purchase records 120 comprising an item ID, ISBN data, the school, a platform SKU, cost, the vendor/platform for which the ebook was obtained, student id data (e.g., email addresses 122 and names 124), a registration (i.e., purchase) code used to obtain the ebook, status and price. As will be described in more detail, the registration code (i.e., purchase code) is utilized to buy the ebook from the associated vendor (Amazon in this case). The storage and management of these records allows the students to seamlessly obtain ebooks from a vendor via the fulfillment system 74 (FIG. 8).

As is evident, master database 71 provides a comprehensive multidimensional knowledge base that links: (a) ebook information from different vendors; (b) school curriculum information for a plurality of different schools and courses; and (c) student fulfillment information for tracking and managing student purchases.

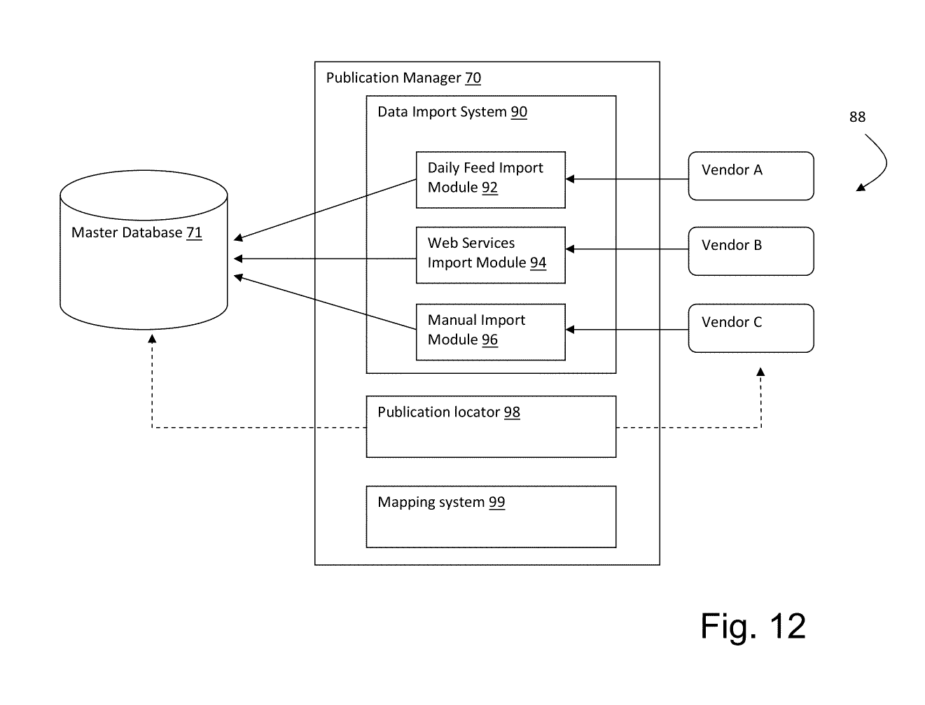

FIG. 12 depicts an illustrative detailed embodiment of publication manager 70. Publication manager 70 interfaces with the master database 71 and participating vendors 88 to provide a comprehensive list of publications and associated information available from the plurality of vendors 88. Publication manager 70 utilizes a data import system 90 to input up-to-date publication data from a plurality of vendors 88. Update-to-date data in the master database 71 is critical as pricing, availability and other information can change on a daily basis. Because each vendor 88 generally uses their own proprietary platform and interface for sharing data, data import system 90 includes a plurality of import modules 92, 94, and 96. In this illustrative embodiment, three import modules are employed, including a daily feed import module 92 utilized to obtain periodic data dumps from Vendor A; a web services import module 94 utilized to dynamically collect data from Vendor B via a web services interface; a manual import module 96 utilized to obtain publication data from Vendor C, e.g., using a manual user interface, etc. It is understood that any number of import modules may be utilized. Accordingly, depending on the vendor's interface capabilities, an import module can be added or reconfigured to allow for any type of data transfer from any vendor system, including, e.g., a periodic batch dump, a real-time dynamic upload, or manual entry, etc.

It is understand however that master database 71 does not need to store all publication data from all of the vendors 88. Instead, data import system 90 selectively identifies and stores only entries that have been requested or utilized by one of the participating schools. Anytime a school requires a book not found in the master database 71, a publication locator 98 will go out and ping the participating vendors 88 to determine who has the title and then load the associated publication data into the master database 71.

In addition, publication manager 70 includes a mapping system 99 that generates a unique platform specific identifier for each title/platform combination. For instance, although “Of Mice and Men” has a unique ISBN, mapping system 99 generates a unique identifier for each platform on which the title exists. Thus, “Of Mice and Men” on the Kindle has a unique identifier that is different from a unique identifier for the Nook. Mapping system 99 links such instances so that they can be easily searched and processed. In addition, mapping system 99 also links alternative versions of titles such that, e.g., the annotated version of a title can be linked to the original version.

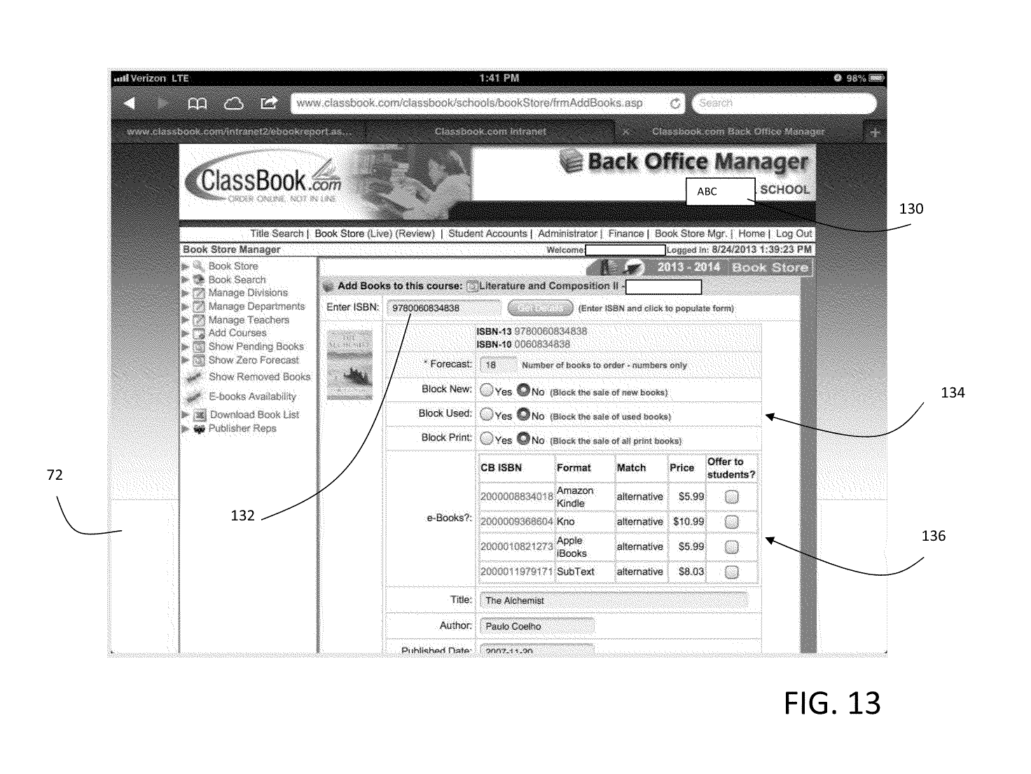

FIG. 13 depicts an example of a back office manager 72. Back office manager 72 provides the interface and infrastructure for allowing an administrator (e.g., teacher) for a selected school 130 to select books for their curriculum. In this example, the administrator enters an ISBN 132 and other relevant information (e.g., number of copies required, whether the search should include new, used or print versions, etc.). The available ebook formats are then presented to the administrator 136, who can select which format(s) should be offered to the students.

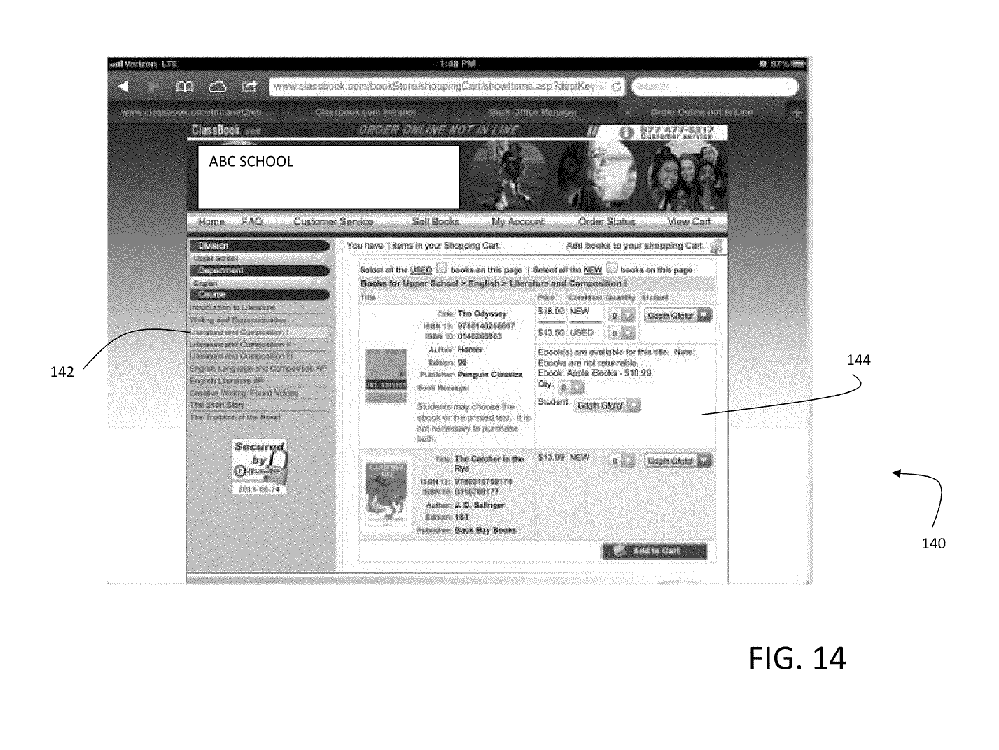

FIG. 14 depicts a shopping cart interface 140 for allowing a student to purchase books for a curriculum associated with the student's school. In this example, the student has logged into to the online store and has selected a course 142, Literature and Composition I, the student is enrolled in. A list of books 144 required for the course is then displayed, including print and ebook options. From this single point of access, the student can enter payment information and obtain digital copies from multiple ebook vendors.

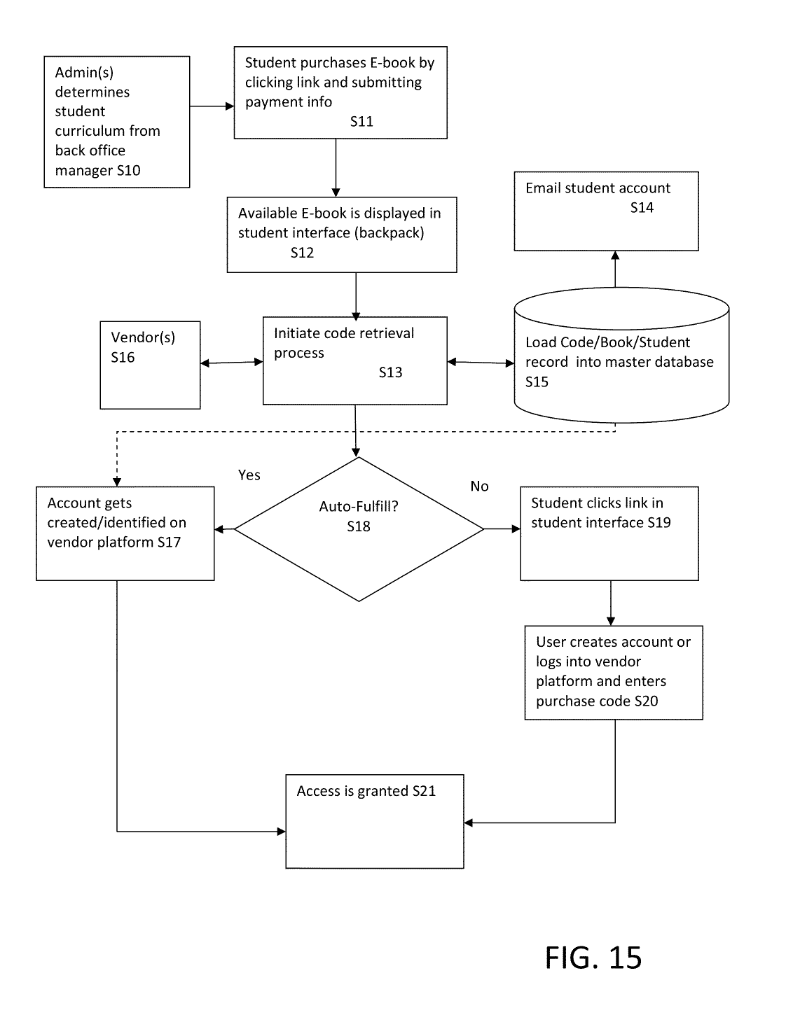

FIG. 15 depicts a flow diagram of an illustrative order fulfillment process. Initially, at S10, one or more administrator(s)/teacher(s) utilizes the back office manager 72 to select a curriculum, e.g., for a student, class, or grade level. The curriculum includes a set of ebooks (as well as printed books) that will be made available to a set of associated students.

At S11, the student can initiate purchase of one or more ebooks by visiting the online store which will, e.g., place the selection into a shopping cart. Once all selections are made, the student can submit the necessary payment information such as credit card data. Of particular note is that although the selected ebooks may be coming from different vendors, a common payment interface process is implemented that resides between the student interface and each vendor. This thus allows the student to make multiple purchases from different vendors without having to deal with multiple different vendor interfaces to obtain the requisite set of ebooks (or print books) for the student's assigned curriculum.

When a student opens and signs into their student interface (i.e., backpack) on a computing device, a list (e.g., set of icons) of required and/or available ebooks will be displayed for the student at S11.

At S13, a code retrieval process is initiated that causes one or more purchase codes to be obtained from the vendor or vendors S16. Purchase codes may for instance comprise a string of alphanumeric characters that are recognized by the vendor as proof of payment (e.g., similar to a gift card). Once each purchase code is obtained, a purchase code record is loaded into the master database at S15 that includes the purchase code, an ebook identifier and student user id (e.g., email), e.g., as shown in FIG. 10.

Next, as S18, a determination is made whether an auto-fulfill process is supported by the vendor of a purchased ebook. Auto-fulfill utilizes a process (i.e., software program) that automatically interfaces with the vendor to create or identify a user account with the vendor at S17. Once the user account is confirmed, the purchase code is transferred to the vendor. In particular, the purchase code record can be obtained from the master database and utilized to effectuate purchase and delivery of the ebook for the associated student id. Accordingly, if auto-fulfill is supported, delivery and/or access is granted by the vendor to the student at S21 with no additional requirements by the student or fulfillment system 74 (FIG. 8).

If auto-fulfill is not supported by the vendor, the student and/or fulfillment system 74 may be required to perform some additional steps. For example, the student may have to click on a link in the student interface at S19 and create or log into an account at the vendor's platform at S20. The code can be entered into the vendor system via some other process either then or ahead of time, e.g., using a cut and paste operation from an email sent to the student at S14, using batch processing with the vendor, etc. Once entered, access to the ebook is granted.

While shown and described herein as electronic publication indexing and provision solution, it is understood that the invention further provides various alternative embodiments. For example, in one embodiment, the invention provides a computer-readable/useable medium that includes computer program code to enable a computer infrastructure to provide electronic publication indexing and provision as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide electronic publication indexing and provision functionality. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for electronic publication indexing and provision. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. An ebook distribution engine, comprising:
a database for storing and managing data, including:
ebook data from a plurality of ebook vendors;
curriculum data for a plurality of schools; and
fulfillment data including ebook purchase information for individual students at each of the plurality schools;
a back office manager having an interface into the database for managing the curriculum data;
a publication manager for importing ebook data from the plurality of ebook vendors into the database; and
a fulfillment system that effectuates purchase and delivery of ebooks from the ebook vendors to the students.

2. The ebook distribution engine of claim 1, wherein the ebook data includes title, pricing, availability, ISBN data, and platform specific identifiers.

3. The ebook distribution engine of claim 1, wherein the curriculum data includes publications required for different courses offered at each of the plurality of schools.

4. The ebook distribution engine of claim 1, wherein the fulfillment data includes student identifiers, purchase histories, and purchase codes.

5. The ebook distribution engine of claim 1, wherein the back office manager allows a user to manage curriculum data for a specific school with which the user is affiliated.

6. The ebook distribution engine of claim 1, wherein the publication manager includes a plurality of import modules for interfacing with different ebook vendors.

7. The ebook distribution engine of claim 1, wherein the publication manager maps an ISBN identifier for a title to a plurality of platform specific identifiers for which the title is available as an ebook.

8. The ebook distribution engine of claim 1, wherein the fulfillment system allows a student to access ebooks for an associated curriculum from different vendors on a client computing device running a student interface.

9. A computer program product stored on a computer readable medium, which when executed by a computer system having a processor and memory, provides an ebook distribution engine, the computer program product comprising:
a database for storing and managing data, including:
ebook data from a plurality of ebook vendors;
curriculum data for a plurality of schools; and
fulfillment data including ebook purchase information for individual students at each of the plurality schools;
program code that provides an interface into the database for managing the curriculum data;
program code for importing ebook data from the plurality of ebook vendors into the database; and
program code that effectuates purchase and delivery of ebooks from the ebook vendors to the students.

10. The computer program product of claim 9, wherein the ebook data includes title, pricing, availability, ISBN data, and platform specific identifiers.

11. The computer program product of claim 9, wherein the curriculum data includes publications required for different courses offered at each of the plurality of schools.

12. The computer program product of claim 9, wherein the fulfillment data includes student identifiers, purchase histories, and purchase codes.

13. The computer program product of claim 9, wherein the curriculum data can be managed for a specific school with which a user is affiliated.

14. The computer program product of claim 9, wherein the program code for importing ebook data includes a plurality of import modules for interfacing with different ebook vendors.

15. The computer program product of claim 9, wherein the program code that effectuates purchase and delivery of ebooks allows a student to access ebooks for an associated curriculum from different vendors on a client computing device running a student interface.

16. The computer program product of claim 9, wherein the program code for importing ebook data maps an ISBN identifier for a title to a plurality of platform specific identifiers for which the title is available as an ebook.

17. A fulfillment system for distributing ebooks, comprising:
a computing system having a memory and processor;
a database for storing and managing ebook data from a plurality of ebook vendors;
an on-line store that outputs a list of selected ebooks available from the plurality of ebook vendors and that collects payment data to initiate ebook purchases from the plurality of ebook vendors;
a code retrieval system that obtains purchase codes from the plurality of ebook vendors in response to collected payment data and that stores the purchase codes along with a user id in the database; and
an auto-fulfill system that automatically submits purchase codes to the set of ebook vendors to obtain access to purchased ebooks for an associated user id.

18. The fulfillment system of claim 17, wherein the list of selected ebooks is determined by a curriculum generated by a back office manager.

19. A computerized method for distributing ebooks, comprising:
providing a computer database for storing and managing ebook data from a plurality of ebook vendors;
outputting a list of selected ebooks available from the plurality of ebook vendors to a user interface on a remote computing device;
collecting payment data from the user interface to initiate ebook purchases from the plurality of ebook vendors;
obtaining purchase codes from the plurality of ebook vendors in response to collected payment data and storing the purchase codes along with a user id in the database; and
automatically submitting purchase codes to the plurality of ebook vendors to obtain electronic access to purchased ebooks for an associated user id.

20. The computerized method of claim 19, wherein the list of selected ebooks is determined by a curriculum stored in the database.

21. The computerized method of claim 20, wherein the curriculum is created via a second user interface.
